(19) United States
(12) Patent Application Publication
(10) Pub. No.: US 2026/0312884 A1
(43) Pub. Date: Oct. 8, 2026

(54) CHANNEL MEASUREMENT RESOURCE CONFIGURATION FOR ARTIFICIAL INTELLIGENCE - CHANNEL STATE INFORMATION

(71) Applicant: Telefonaktiebolaget LM Ericsson (publ), Stockholm (SE)

(72) Inventors: Xinlin ZHANG, FROLUNDA (SE); Ilmiawan SHUBHI, MALMO (SE); Jingya LI, GOTEBORG (SE); Zhilan XIONG, SOLNA (SE); Mattias FRENNE, UPPSALA (SE)

(21) Appl. No.: 19/484,795

(22) PCT Filed: May 15, 2024
(86) PCT No.: PCT/IB2024/054742

§ 371 Date: Nov. 14, 2025

Related U.S. Application Data
(60) Provisional application No. 63/466,569, filed on May 15, 2023.

(51) Int. Cl. H04L 41/16; H04B 7/06

(52) U.S. Cl. CPC H04L 41/16; H04B 7/0626

(57) ABSTRACT

Methods and systems are described for training or evaluating AI/ML models related to channel measurement resource triggering signals. For example, a CMR configuration for AI/ML based CSI prediction may be implemented where the CMR configuration comprises a pair of CSI-RS resource bursts where each burst contains at least one CSI-RS resource. The pair of bursts can be triggered with a single aperiodic trigger in a DCI message from the network (NW) to the UE. The bursts can be separated in time, and can be configured for data collection or monitoring purposes for AI/ML-based CSI prediction.

### CROSS REFERENCE TO RELATED INFORMATION

This application claims the benefit of United States of America priority application No. 63/466,569 filed on May 15, 2023, titled “CMR Configuration for AI-CSI.”

### TECHNICAL FIELD

The present disclosure generally relates to systems and methods for training or evaluating machine learning models related to channel measurement resource triggering signals.

### BACKGROUND

Artificial Intelligence (AI), and Machine Learning (MIL) have been investigated as promising tools to optimize the design of air-interface in wireless communication networks in both academia and industry. Example use cases include using autoencoders for channel state information (CSI) compression to reduce the feedback overhead and improve channel prediction accuracy; using deep neural networks for classifying line of sight (LOS) and non-line of sight (NLOS) conditions to enhance positioning accuracy; and using reinforcement learning for beam selection at the network side and/or the user equipment (UE) side to reduce the signaling overhead and beam alignment latency; using deep reinforcement learning to learn an optimal precoding policy for complex multiple input multiple output (MIMO) precoding problems.

In 3rd Generation Partnership Project 3GPP new radio (NR) standardization work, a new release 18 (Rel-18) study item on AI/ML for NR air interface has started since May 2022. This study item (SI) explores the benefits of augmenting the air-interface with features enabling improved support of AI/ML based algorithms for enhanced performance and/or reduced complexity/overhead. Through studying a few selected use cases (CSI feedback, beam management and positioning), this SI aims at laying the foundation for future air-interface use cases leveraging AI/ML techniques.

A possible high-level description of model lifecycle management such as may be used for AI models on the physical layer (PHY) that may be used in AI applications as described above can include the stages and data/signal flows depicted in FIG. 1. Further description can be found at “Discussion on general aspects of AI ML framework,” 3GPP TSG-RAN WG1 Meeting #110-bis-e, Tdoc R1-2208908, available at https://www.3gpp.org/ftp/tsg_ran/WG1_RL1/TSGR1_110b-e/Docs. As shown in FIG. 1, model lifecycle management may include stages of Data Collection, Model Training, Model Deployment, Model Inference, and Model Monitoring. In those stages, Data Collection is a stage that collects and provides input data (raw data or pre-processed data) for Model Training, Model inference and Model Monitoring. AI/ML, algorithm specific data preparation (e.g., data ingestion and data refinement) is not carried out in the Data Collection stage. Model Training is a process that uses featured data in terms of training datasets and validation datasets to train an AI/ML model. Model deployment is a process of converting an AI/ML, model into an executable form and delivering it to a target UE for inference where model inference is to be performed. Model inference is a process of using a deployed AI/ML, model to produce a set of outputs based on a set of featured inputs. Model monitoring is a process that monitors drifts in data and model or monitoring performance metrics after the model has been deployed. Based on the monitored performance, decisions like model activation/deactivation/switching/fallback/selection can be taken.

In 3GPP NR Rel-18, channel measurement resource (CMR) enhancement for Type II CSI prediction (a.k.a. Rel-18 Type II CSI) has been introduced. To be more specific, a single burst of K∈{4, 8, 12} channel state information reference signal (CSI-RS) resources can be configured to the UE within a single CSI-RS resource set, which can be aperiodically triggered using a single downlink control information (DCI). The CSI-RS resources are uniformly spaced in time, separated by m∈{1, 2} slots, within the resource set. For the Rel-18 Type II pre-coding matrix indicator (PMI) enhancement, UE can be configured by a 5G base station (gNB) to report predicted PMIs for N₄∈{1, 2, 4} time slots. Note that the prediction herein is relative to the CSI-RS reference resource. The predicted N₄ PMIs are supposed to reflect the channels with d∈{1, 2} slots separation, starting from δ∈{0,1,2} slots into the future relative to the CSI-RS reference resource. The spacing d between the N₄ PMIs and offset δ relative to the CSI-RS reference resource can be configured by the gNB via radio resource control (RRC) signaling. The N₄ PMIs are compressed in a beam-frequency-Doppler domain, and the compressed PMI is reported to the gNB in a single CSI report. An illustration of this CRM enhancement for Rel-18 Type II PMI is provided in FIG. 2.

### SUMMARY

One embodiment under the present disclosure comprises a method performed by a UE for training or evaluating a machine learning model. The method comprises receiving a channel measurement resource triggering signal from a network node; and performing, based at least in part on the channel measurement resource triggering signal, a first set of measurements and a second set of measurements. It further comprises generating, with the machine learning model, a plurality of predictions based on the first set of measurements; and measuring performance of the machine learning model by performing one or more comparisons, wherein the one or more comparisons compare data from the second set of measurements and a set of predictions from the plurality of predictions.

Another embodiment of a method under the present disclosure is a method performed by a network node for evaluating a machine learning model. The method comprises sending a channel measurement resource triggering signal to a UE; and receiving from the UE, after sending the channel measurement resource triggering signal, a first set of measurements and a second set of measurements. It further comprises generating, with the machine learning model, a plurality of predictions based on the first set of measurements; and measuring performance of the machine learning model by performing one or more comparisons, wherein the one or more comparisons compare data from the second set of measurements and a set of predictions from the plurality of predictions.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates different AI/MIL model life cycle management;

FIG. 2 is an Illustration of CMR enhancement for Rel-18 Type II PMI;

FIG. 3 shows a possible proposed CMR configuration with a pair of CSI-RS bursts;

FIG. 4 shows another possible proposed CMR configuration with a pair of CSI-RS bursts;

FIG. 5 shows a possible proposed CMR configuration with a pair of CSI-RS bursts, where the second burst has only 1 CSI-RS resource;

FIG. 6 shows a possible proposed CMR configuration with a pair of CSI-RS bursts, where density of CSI-RS resources in the second burst is half as the density of the predicted CSI;

FIG. 7 shows an example of port correspondence among all NZP CSI-RS resources with a CMR with two CSI-RS bursts with the same number of ports;

FIG. 8 shows an example of port correspondence among all NZP CSI-RS resources with a CMR with two CSI-RS bursts, where the two bursts have different number of ports;

FIG. 9 shows a possible proposed pair of CSI-RS bursts transmitted/configured periodically within a time window T3;

FIG. 10 illustrates a flow-chart of a method embodiment under the present disclosure;

FIG. 11 illustrates a flow-chart of a method embodiment under the present disclosure;

FIG. 12 shows a schematic of a communication system embodiment under the present disclosure;

FIG. 13 shows a schematic of a user equipment embodiment under the present disclosure;

FIG. 14 shows a schematic of a network node embodiment under the present disclosure; and

FIG. 15 shows a schematic of a virtualization environment embodiment under the present disclosure.

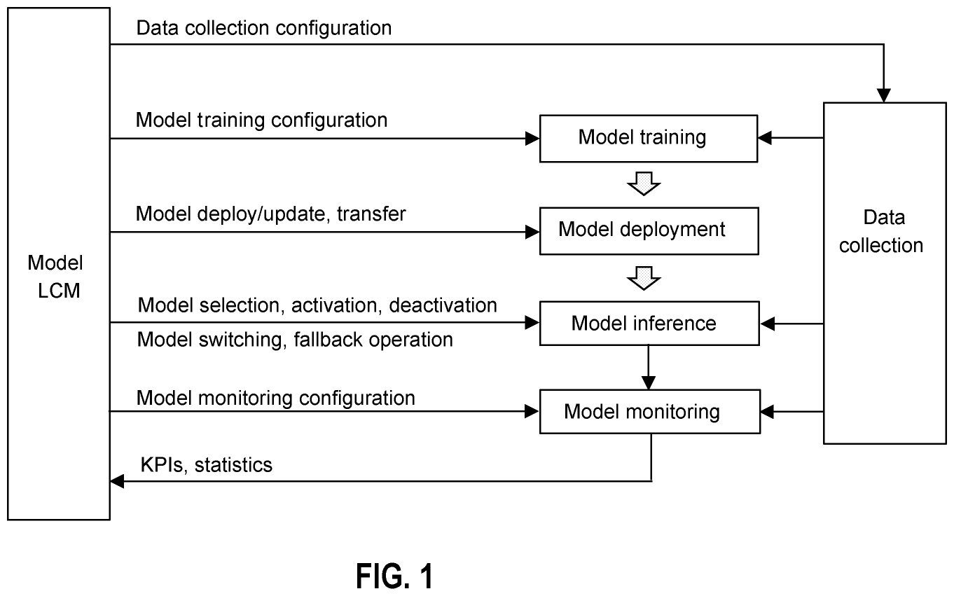

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges. The CSI-RS enhancement introduced in Rel-18, which is composed of a burst of NZP CSI-RS resources in a single CSI-RS resource set, cannot be directly used for model training and model monitoring purposes since for such purposes and for supervised training, a ground truth is needed so that the output of the model inference can be compared with such ground truth. With a single CSI-RS burst as in legacy, it is inflexible or difficult to obtain the ground truth for a predicted PMI.

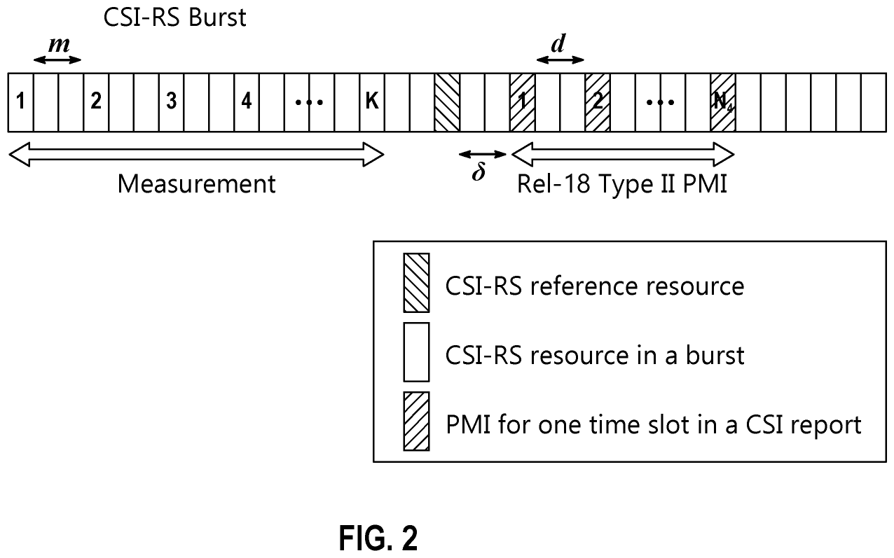

For model training of an AI/ML model for CSI prediction, the training data should comprise not only the channel measurements the model input (e.g., the measurements on the CSI-RS resources in a burst shown in FIG. 2), but also the ground truth data (e.g., the actual channel measurements for the time slots which the predicted CSI corresponds to). The ground truth data may be used in calculating the loss during model training. It is a problem how to configure the CSI to allow this.

Similarly, for model monitoring of an AIL/M model for CSI prediction, the training data should also comprise both the channel measurements for model input (which is fed into the model to generate model output) and the ground truth data for deriving the inference accuracy related metrics like prediction accuracy for model performance monitoring. It is a problem how to configure the CSI to allow this.

The CIR configuration framework specified in Rel-18 for Type II CSI prediction, which is composed of a burst of non-zero power channel state information reference signal (NZP CSI-RS) resources which are uniformly spaced in time in a single CSI-RS resource set, can be reused for collecting measurement data for model inference, however, it is a problem that it is inflexible and difficult to be reused to support the data collection for model training and model monitoring purposes.

Certain aspects of the disclosure and their embodiments may provide solutions to these or other challenges. A CMR configuration for AI/ML, based CSI prediction may be implemented based on this disclosure, where the CMR configuration comprises a pair of CSI-RS resource bursts where each burst contains at least one CSI-RS resource. The pair of bursts can be triggered with a single aperiodic trigger in a DCI message from the network (NW) to the UE. The bursts are separated in time, and can be configured for data collection or monitoring purposes for AI/ML-based CSI prediction.

In such a configuration the first CSI-RS resource burst may comprise more than one NZP CSI-RS resources within a first time window T1, and may be used for collecting measurement results related to a model input. The second CSI-RS resource burst may comprise one or more NZP CSI-RS resources within a second time window T2, and may be used for collecting measurement results related to the ground truth of a model output. The length of the time windows T1 and T2 may be different and thus independently configured. The time spacing (interval) between different CSI-RS resources in T1 and the time spacing between different CSI-RS resources in T2 may or may not have the same value, i.e. they may have independent configurations from the NW to the UE.

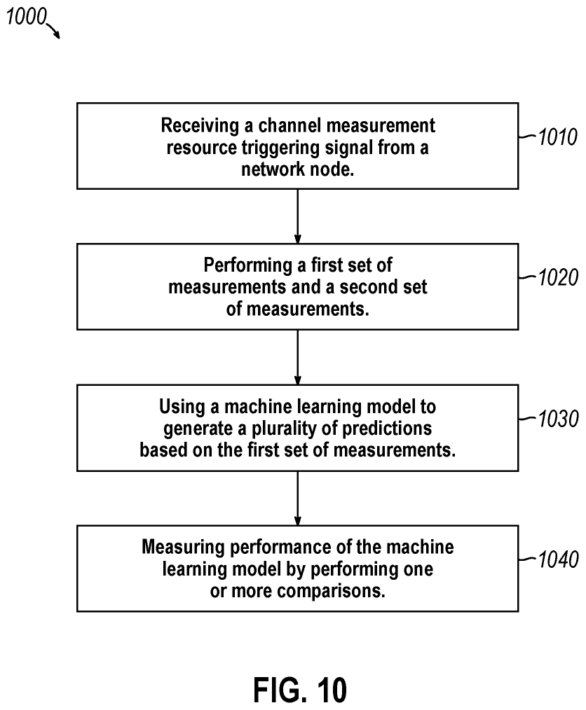

For models that are trained/monitored at the UE-side (e.g., for UE-sided AI model for CSI prediction), a UE collects the measurements on the CSI-RS resources indicated by the CMR configuration, and the measurements are used for creating training/monitoring data samples for the model training/monitoring. An example of a method which may be performed by a UE in this context is provided in FIG. 10. FIG. 10 shows a method 1000 performed by user equipment for evaluating a machine learning model. Step 1010 is receiving a channel measurement resource triggering signal from a network node. Steps 1020-1040 may be performed based on the channel measurement resource triggering signal, as a set of data collection and evaluation acts. Step 1020 is performing a first set of measurements and a second set of measurements. Step 1030 is using a machine learning model to generate a plurality of predictions based on the first set of measurements. Step 1040 is measuring performance of the machine learning model by performing one or more comparisons. These one or more comparisons may be comparison comparing data from the second set of measurements and a set of predictions from the plurality of predictions. Method 1000 can comprise a variety of alternative, additional or optional steps or other variations.

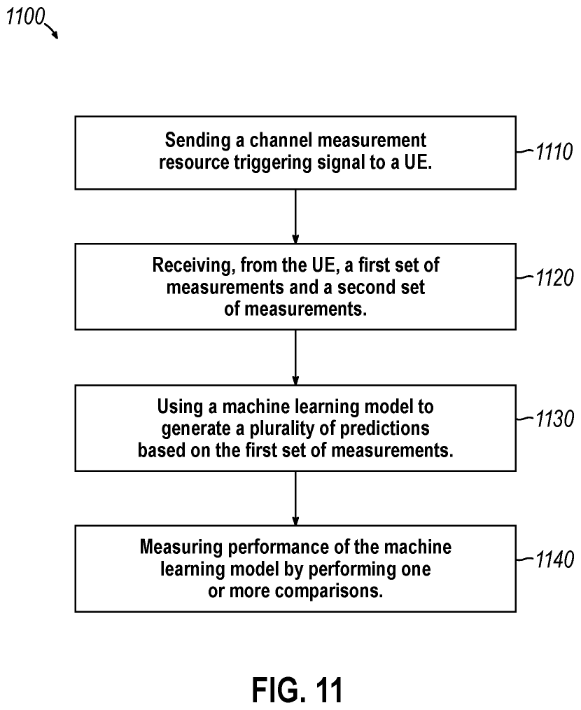

For models that are trained/monitored at the network-side (e.g., for network-sided AI model for CSI prediction), one or more UE(s) is/are configured to perform measurements on the CSI-RS resources indicated by the CMR configuration, and report the measurement results to the network, based on which the network creates training/monitoring data samples for model training/monitoring. An example of a method which may be performed by a network node in this context is provided in FIG. 11. FIG. 11 shows a method 1100 performed by a network node for evaluating a machine learning model. Step 1110 is sending a channel measurement resource triggering signal to a user equipment. Steps 1120-1140 may be performed as a set of data collection and evaluation acts after sending the channel measurement resource triggering signal to the user equipment. Step 1120 is receiving, from the UE, a first set of measurements and a second set of measurements. Step 1130 is using a machine learning model to generate a plurality of predictions based on the first set of measurements. Step 1140 is measuring performance of the machine learning model by performing one or more comparisons. The one or more comparisons may be comparisons comparing data from the second set of measurements and a set of predictions from the plurality of predictions. Method 1100 can comprise a variety of alternative, additional or optional steps or other variations

Certain embodiments may provide one or more of the following technical advantage(s). Embodiments may enable data collection for model training and model monitoring for the AI/ML-based CSI prediction use case, by providing resources for channel measurement and for obtaining ground truth. Embodiments may be implemented in a manner which has low reference signal and signaling overhead.

Some of the embodiments contemplated herein will now be described more fully with reference to the accompanying drawings. Embodiments are provided by way of example to convey the scope of the subject matter to those skilled in the art.

Disclosed embodiments may implement methods for efficiently configuring and triggering CMRs that can be used for AI/MLL-based CSI prediction. Such methods can be used for data collection for model training and/or model monitoring. In principle, AI/MIL-based CSI prediction model inference may reuse a similar CSI reporting framework as proposed in 3GPP Rel-18 Type II CSI enhancement, where the UE can report PMIs that reflect the channel for a number of time slots into the future. However, AI/ML-based CSI prediction may allow different values for the parameters, such as d and δ. Even though the Rel-18 Type II CSI prediction reporting framework can be reused for AI/ML-based CSI prediction model inference, the CMR configuration needs to be enhanced to support data collection for model training and model monitoring purposes, so that the ground truth for a predicted PMI can be obtained in an efficient manner.

In some embodiments, the CMR is extended so that it may contain a pair of CSI-RS bursts, separated in time, configured to the UE for AI/MIL-based CSI prediction use case, where the configured CMR can be used by the UE for collecting training data for model training, or for the UE to collect monitoring data for model monitoring. The first CSI-RS burst within the CMR, containing more than one NZP CSI-RS resources within a first time window T1 (or equivalently described, for K₁ transmissions of NZP CSI-RS resources at different slots), can be used by the UE to collect channel measurements for model input, based on which a predicted CSI is obtained through AI/ML model inference, while the second CSI-RS burst within the CMR, containing one or more NZP CSI-RS resources within a second time window T2 (or equivalently described, for K₂ transmissions of NZP CSI-RS resources at different slots), can be used by the UE for generating ground truth for model output, which can further be used for calculating the difference between the predicted CSI (from inference based on the measurements in the first burst) and ground truth CSI (from measurements in the second burst). The CSI-RS resource occasions in time in the second burst overlap, or at least partly overlap, with the time slots for which a predicted CSI is valid for.

The CMR configuration parameters (e.g., the number of CSI-RS resources and the separation in time of the CSI-RS resources within the first burst, the number of CSI-RS resources and the separation in time of the CSI-RS resources within the second burst, or the time duration of each bust (T1 and T2)) are explicitly (e.g. by RRC or MAC CE signaling) or implicitly configured by the network based on the required or/and reported UE capabilities for the associated AI based CSI-prediction functionality or functionalities. Here, a required UE capability refers to a set of parameters that are pre-defined in the specification and must be fulfilled as minimum requirement for a UE to claim that it is capable of AI/ML-based CSI prediction feature.

The CMR configuration parameters can also be configured by the network based on the received applicable conditions or/and data collection request signaled from the UE. An example of the application condition indication is that the UE reports that it currently is able to perform CSI prediction into the future for at most X ms or Z slots. Alternatively, the UE may report a data collection request where a UE can indicate to the network that it wants to reduce the number of CSI-RS measurements for CSI prediction, or it wants to reduce the prediction horizon.

In some embodiments, the CMR configuration parameters (e.g., the number of CSI-RS resources within the first burst, the number of CSI-RS resources within the second burst, the time duration of each bust) are (higher layer) configured based on the reported UE capabilities of the AI based CSI-prediction functionality/functionalities, or/and the application condition indicated by the UE, or/and the data collection request from the UE.

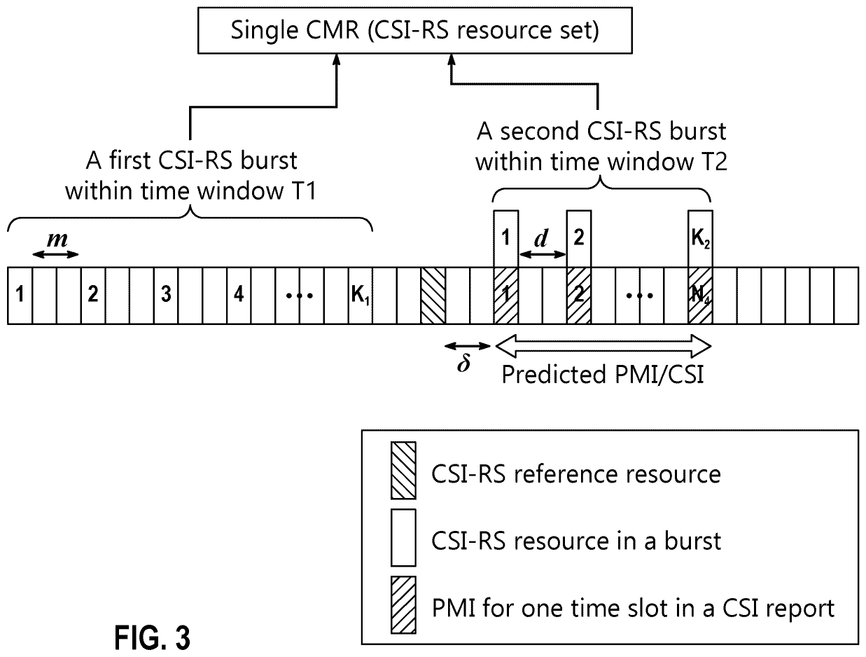

FIG. 3 provides an example of this type of configuration, where a CMR that contains two CSI-RS bursts is configured to the UE. The two bursts contain K₁>1 and K₂≥1 NZP CSI-RS resources, respectively. The separation in time between the NZP CSI-RS resources in the two bursts are m slots and d slots, respectively. The separation in time for the first CSI-RS burst is the same as the configuration for collecting measurements as the input for model inference. The separation in time for the second CSI-RS burst is the same as the separation between adjacent predicted CSI/PIs for model inference.

In one type of embodiment, as illustrated in the example of FIG. 3, the configuration parameters for the first CSI-RS resource burst (e.g., number of NZP CSI-RS resources in the first burst and the time spacing between adjacent CSI-RS resources) are the same as the CSI-RS resource burst configuration parameters (e.g., K and m) for collecting measurements as the model input for model inference. In this type of embodiment, the configuration parameters for the second CSI-RS resource burst (e.g., the number of NZP CSI-RS resources in the second burst and the time spacing between adjacent CSI-RS resources) may be the same as the number of time slots and time spacing for which a predicted CSI/PMI should be reported, i.e., K₂=N₄ and d is used for the time spacing between adjacent CSI-RS resources in the second burst. With this setting, the configured CMR can be used for both model training and model monitoring. If this approach is incorporated into a 3GPP specification, it may describe the first and second CSI-RS bursts so that the UE will treat the first one for model input and the second for ground truth estimation. As an alternative, in some embodiments two CMRs are configured independently but linked in the specifications so that the UE will use the first one for model input and the second for ground truth estimation. In an example of an embodiment, the configuration for the second CSI-RS burst may be directly derived from (or be restricted to) the N₄, δ, and d values.

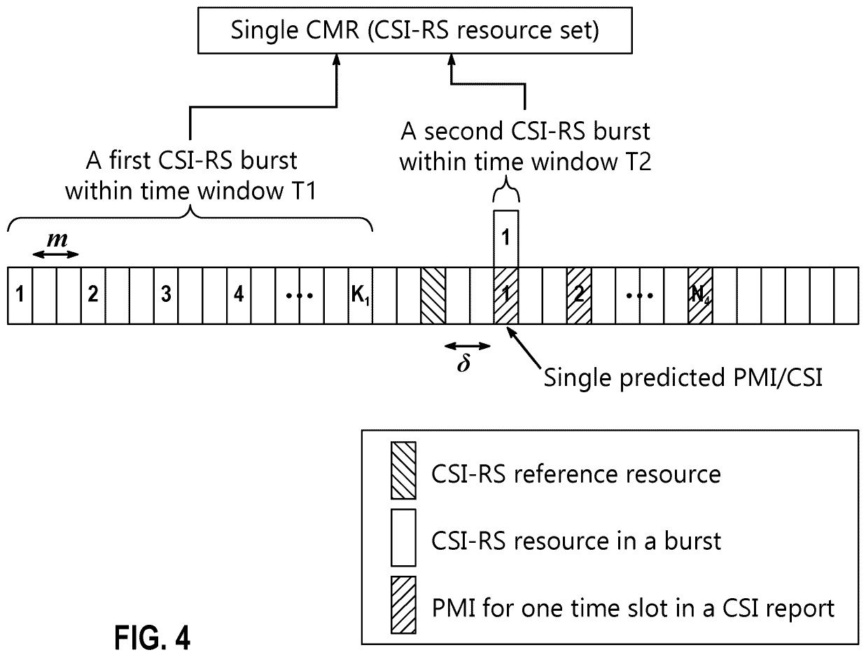

In another type of embodiment, the CSI-RS resources in the first or/and second burst are not uniformly spaced in time, and the time occasions of the CSI-RS resources are separately configured. For instance, several parameters d₁, d₂, d₃, . . . are configured to indicate the CSI-RS resources in the second burst associated to the time instances for which predicted CSI/PMI should be generated. In some cases, the UE may only be configured to predict a future CSI/PMI for a single time instance, i.e., N₄=1. In these cases, the second CSI-RS burst contains only one CSI-RS resource. Moreover, the time instance for which the predicted CSI is valid for and the time instance for which the NZP CSI-RS of the second CSI-RS burst is transmitted are the same. This is illustrated in FIG. 4, in which the second burst only contains a single instance of NZP CSI-RS resources and the UE is only configured to report a predicted CSI/PMI for a single time instance (N₄=K₂=1).

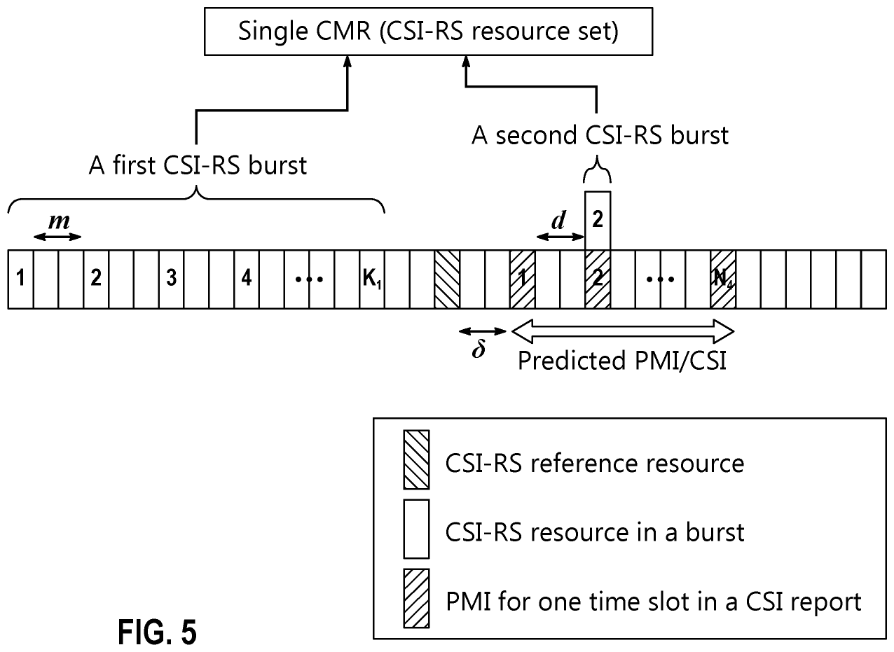

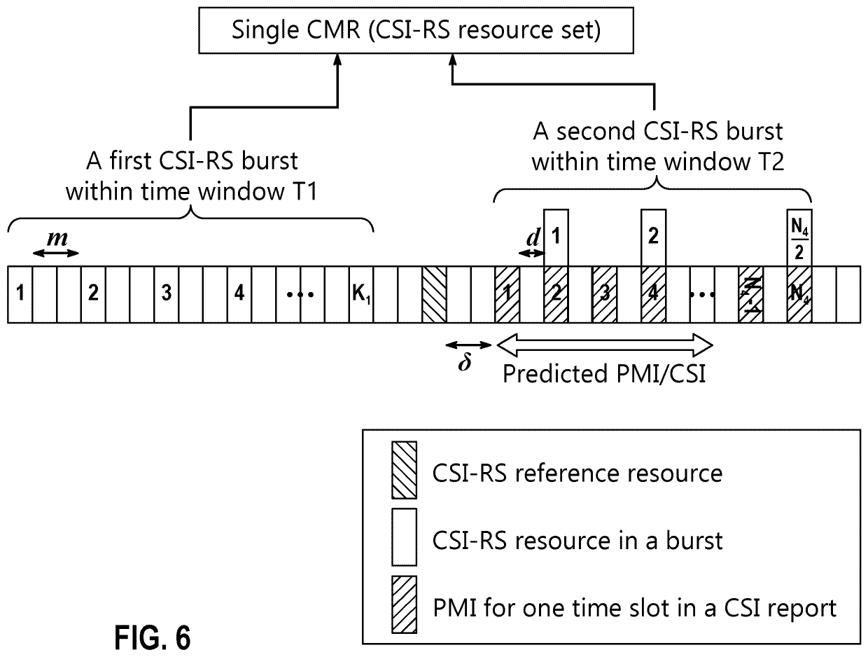

In another type of embodiment, the second CSI-RS burst contains fewer NZP CSI-RS resources than the number of time slots for which CSI/PMIs are predicted, i.e., K₂<N₄. This setting can be used for model monitoring with lower CSI-RS transmission/measurement overhead, as it might be enough to monitor the prediction accuracy for a subset of time slots for which the CSI/PMIs are predicted. This setting can also be used for collecting training data to train or retain a model that predicts CSI/PMI over a shorter time horizon (e.g., a shorter T2) or predicting CSI/PMI with a larger granularity in time domain (e.g., a larger d). An example is shown in FIG. 5, where the second CSI-RS burst only contains a single NZP CSI-RS resource. Then the ground truth obtained with the second CSI-RS burst (a single instance) can be used to monitor the prediction accuracy of predicted CSI within the prediction window. Another example is shown in FIG. 6, where the second CSI-RS burst contains

$$\frac{{N}_{4}}{2}$$

NZP CSI-RS resources (half the density as predicted CSI). Then, the ground truth obtained with the second CSI-RS burst (N₄/2 instances) can be used to monitor the prediction accuracy.

In some embodiments, the UE may simply be configured with a K₂ value, where K₂<N₄ (or K₂≤N₄). The UE then may receive the second CSI-RS burst with the same slot of the first K₂ out of N₄ slots in which the CSI should be predicted by the UE. Additionally, the UE may also be configured with another parameter (e.g., s) which determines the start of the second CSI-RS burst. In the example of FIG. 6, s is set to 2 and the K₂ is set to 1, i.e., the UE may receive the second CSI-RS burst only in one slot (as K₂ is set to 1) which starts from the second slot in which the CSI should be predicted by the UE (as s is set to 2). Additionally, or alternatively, the UE may also be configured with another parameter (e.g., p) which determines the periodicity of the CSI-RSs inside the second CSI-RS burst. For example, if K₂ is set to 2, s is set to 2, and p is set to 2, the UE may receive the CSI-RSs of the second CSI-RS burst in the second and fourth slots in which the CSI should be predicted by the UE.

In some embodiments, a bitmap can be assigned to indicate which slots the second CSI-RS burst will be transmitted. Here, the size of the bitmap may be derived from the value of N₄ configured for the UE. For example, in the case of the value of N₄ is 4, the bitmap size will be four bits. Bitmap values of 0101 may be interpreted as the CSI-RS burst may be received by the UE in the second and fourth slots in which the CSI should be predicted by the UE. Note that for the case in which the second CSI-RS burst is agreed to only have a size of 1 slot, the configuration may be in a codepoint instead of a bitmap. For example, with the value of N₄ equal to 4, the codepoint will have a size of ┌log₂ 4┐=2 bits, where, e.g., 01 may indicate that the UE may receive the second CSI-RS burst in the third slot of the slots in which the CSI should be predicted by the UE.

In some embodiments embodiment, the CMR with a pair CSI-RS bursts is in a CSI-RS resource set and is configured to the UE via NZP-CSI-RS-ResourceSet information element (IE) in RRC signaling.

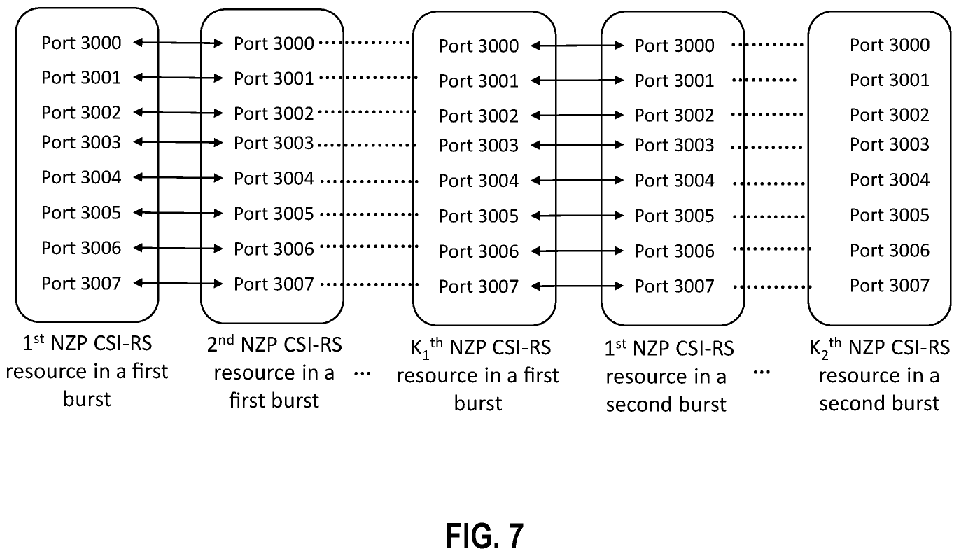

In some embodiments, all the NZP CSI-RS resources in a CMR with a pair of CSI-RS bursts have the same number of CSI-RS ports, and all the ports are pair-wisely the same. This is illustrated in FIG. 7, where all NZP CSI-RS resources contain 8 ports, and each of the 8 ports for all the NZP CSI-RS resources are the same.

In other embodiments all the NZP CSI-RS resources in the first burst have the same number of ports, say

$${N}_{CSI - RS}^{1} ,$$

while all the NZP CSI-RS resources in the second burst have another same number of ports, say

$${N}_{CSI - RS}^{2} ,$$

where

$${N}_{CSI - RS}^{1} > {N}_{CSI - RS}^{2} .$$

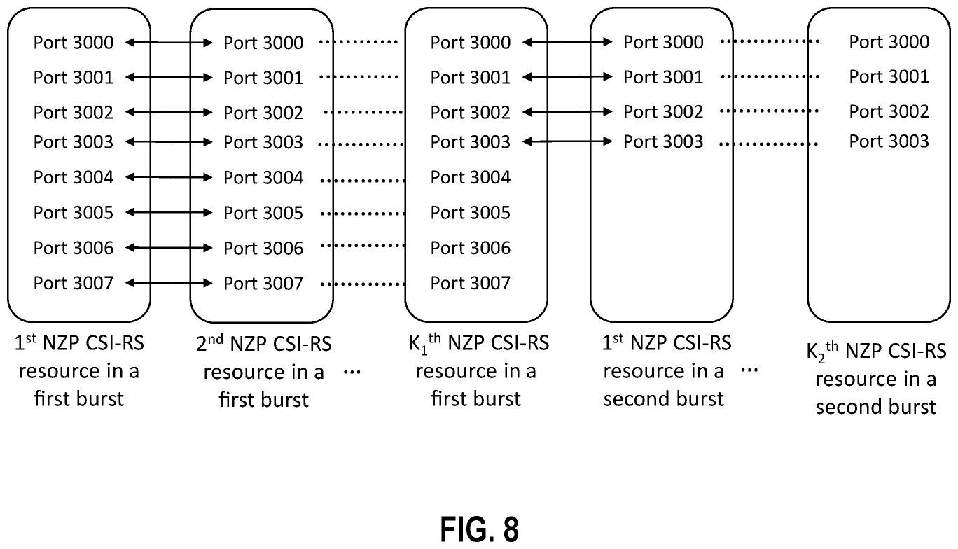

All the ports within a same burst are pair-wisely the same. Each of the ports in the second burst is the same as one and only one port from any one of NZP CSI-RS resources in the first burst. This is illustrated in FIG. 8, where each of the NZP CSI-RS resources in the first burst and the second burst has 8 ports and 4 ports respectively. Such configuration can save CSI-RS overhead for model monitoring, as the prediction accuracy for all ports might be inferred from the prediction accuracy over a subset of CSI-RS ports.

In some embodiments of this type, the port correspondence between the first and second bursts can be pre-determined in 3GPP specifications, for example the

$${N}_{CSI - RS}^{2}$$

ports in the second burst may always be mapped to the first

$${N}_{CSI - RS}^{2}$$

ports in the first burst. Alternatively, mapping rules can be explicitly configured by gNB to UE via CSI-RS resource configuration, or CSI report configuration.

In some embodiments, the antenna ports for the same antenna port index across all CSI-RS resources in the first CSI-RS burst and the antenna ports for the same antenna port index across all CSI-RS resources in the second CSI-RS burst are the same. In some embodiments, all the configured CSI-RS resources in the first CSI-RS burst and the second CSI-RS burst share the same bandwidth (BW) and resource element (RE) locations. In some embodiments, the CMR with a pair of CSI-RS bursts is aperiodically configured to the UE by the gNB. In some embodiments, the CMR with a pair of CSI-RS bursts is periodically configured to the UE. In some embodiments, the CMR with a pair of CSI-RS bursts is semi-persistently configured to the UE.

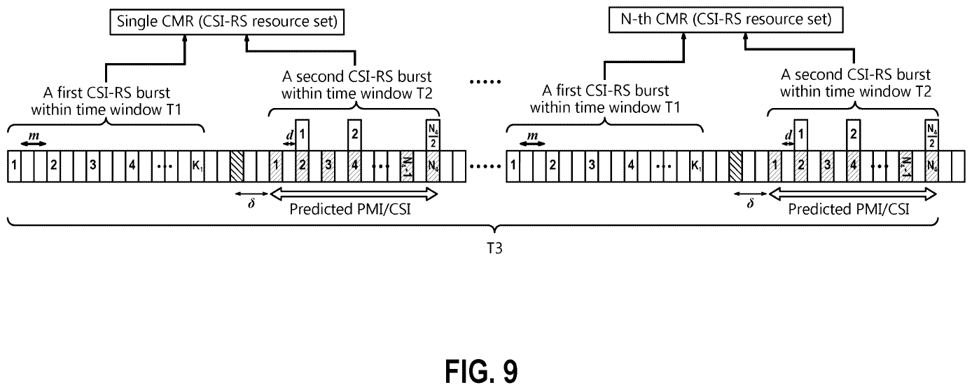

In another type of embodiment, the CMR with a pair of CSI-RS bursts is periodically configured to the UE within a certain time window T3, where T3 can be a training data collection time window, or/and a monitoring data collection time window. For example, T3 can be configured to be multiple times of T1+T2, where T1 is the time window for the first burst, and T2 is the time window for the second burst. As another example, T3 can be configured to be multiple time of T1+T2+delta_T, where delta_T is the time gap between adjacent CSI-RS burst pair transmissions. This is further illustrated in FIG. 9, where a pair of CSI-RS bursts is transmitted/configured periodically within a time window T3.

In some embodiments, the separation in time between adjacent NZP CSI-RS resources in different bursts are jointly configured (e.g., the same value for both bursts). In some embodiments, the separations in time between adjacent NZP CSI-RS resources in different bursts are separately configured (e.g., different separation for different bursts). In some embodiments, the number of NZP CSI-RS resources for the different bursts are separately configured by the gNB to the UE (e.g., different number of NZP CSI-RS resources for different bursts). In some embodiments, the number of NZP CSI-RS resources for the different bursts are jointly configured by the gNB to the UE (e.g., same number of NZP CSI-RS resources for different bursts).

In some embodiments, the time slots for which the UE should predict the CSI is not explicitly configured in a CSI report configuration, instead, they may be inferred from the CMR configuration associated with the configured CSI reporting configuration. For example, the UE can infer the time slots for which a CSI shall be predicted/calculated, based on the occasion of the second CSI-RS burst.

In some embodiments, the slots in which the second CSI-RS burst is transmitted are aligned with the slots in which the CSI should be predicted. To give flexibility to the resource arrangement, a more relaxed requirement may be used. For example, the slot in which the second CSI-RS burst is transmitted may have a maximum g slot difference with the slot in which the UE should predict the CSI. For example, for the case of g=1, the UE should be configured with the second CSI-RS burst, in which the CSI-RS(s) slot of the second CSI-RS burst is (are) aligned or adjacent to the slot in which the UE should predict the CSI. Note that the unalignment between the CSI-RS slot of the second CSI-RS burst and the slot in which the UE should predict the CSI may reduce, e.g., the monitoring performance. Therefore, in one approach, a requirement on whether the CSI-RS slot of the second CSI-RS burst and the slot in which the UE should predict the CSI should be aligned or can have a certain gap may be based on the UE capability report. Here, a UE with a first UE capability may need to be configured with aligned slots, whereas a UE with a second UE capability may be configured with either aligned slots or may accommodate a certain gap between the CSI-RS slots of the second CSI-RS burst with the slots in which the UE should predict the CSI. The first capability may serve as a default capability. In another approach, in case there are CSI-RS resources configured in the second burst not aligned with any predict time instances, the UE does not perform measurements on these misaligned CSI-RS resources or does not use the measurements for model training/monitoring.

It should be noted that although the examples described herein mainly use a CMR with a pair of CSI-RS bursts, the same principle can be easily extended to a CMR with more than two CSI-RS bursts. In that case, 3GPP specification may define a rule to determine the usage of each burst.

It should also be noted that although the first and the second CSI-RS bursts are often referred to herein as the CSI-RS burst pair, it should be understood that the transmission of those CSI-RS bursts does not necessarily have to happen in pair. In some cases, an additional indication may be provided, e.g., via a bitfield in the DCI may give an indication of whether the second CSI-RS burst will be transmitted or not. For example, if the UE only receives an indication to report the predicted CSI, then the UE is expected to only receive the first CSI-RS burst and not receive the second CSI-RS burst. On the other hand, if the UE is also indicated that there will be a second CSI-RS burst transmission (e.g., for monitoring and/or data collection), the UE is expected to receive both the first and the second CSI-RS bursts.

For cases where the AIL/L model for CSI-prediction is trained or/and monitoring at the NW-side. The UE may also be configured to report the measurement results for the CMR with a pair of CSI-RS bursts to the NW.

The triggering of the CMR with two NZP CSI-RS resource bursts (or two linked NZP CSI-RS resources), may be performed using a single aperiodic trigger (state) in the DCI carried by the physical downlink control channel (PDCCH). When the UE receives this trigger, it should perform inference based on the first CSI-RS burst and perform ground truth estimation of the second burst. The network element (NE) may also schedule a physical uplink control channel (PUSCH) at some time after the second burst has completed (plus some defined time that allows for UE processing) in which the data collection and/or monitoring results is reported to the network. The DCI that triggers the CMR(s) and the DCI that triggers the PUSCH for reporting may be the same DCI.

### Additional Embodiments

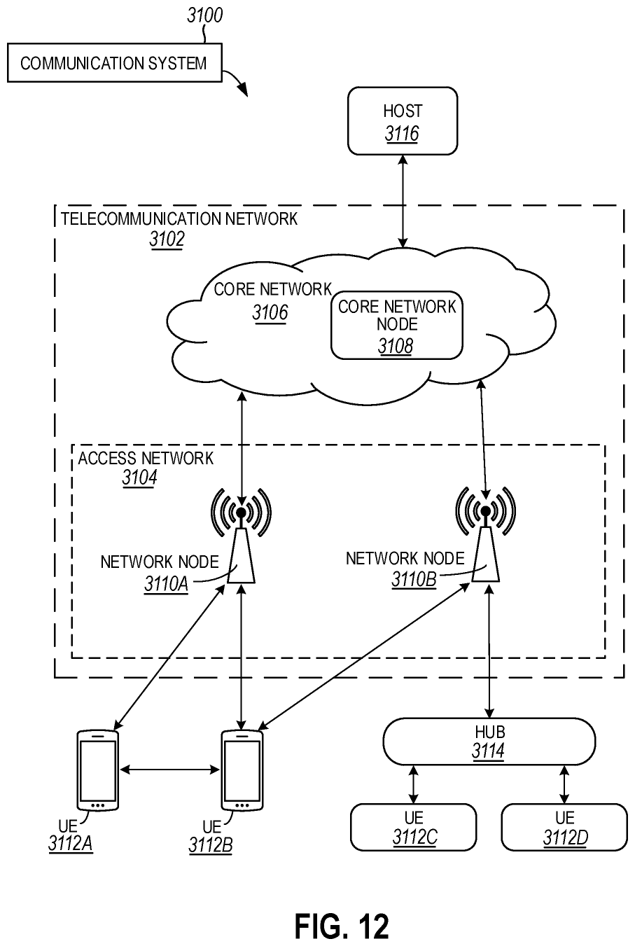

FIG. 12 shows an example of a communication system 3100 in accordance with some embodiments.

In the example, the communication system 3100 includes a telecommunication network 3102 that includes an access network 3104, such as a radio access network (RAN), and a core network 3106, which includes one or more core network nodes 3108. The access network 3104 includes one or more access network nodes, such as network nodes 3110a and 3110b (one or more of which may be generally referred to as network nodes 3110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 3102 includes one or more Open-RAN (ORAN) network nodes. An ORAN network node is a node in the telecommunication network 3102 that supports an ORAN specification (e.g., a specification published by the O-RAN Alliance, or any similar organization) and may operate alone or together with other nodes to implement one or more functionalities of any node in the telecommunication network 3102, including one or more network nodes 3110 and/or core network nodes 3108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 3110 facilitate direct or indirect connection of user equipment (UE), such as by connecting UEs 3112a, 3112b, 3112c, and 3112d (one or more of which may be generally referred to as UEs 3112) to the core network 3106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 3100 may include any number of wired or wireless networks, network nodes, UEs, and/or any other components or systems that may facilitate or participate in the communication of data and/or signals whether via wired or wireless connections. The communication system 3100 may include and/or interface with any type of communication, telecommunication, data, cellular, radio network, and/or other similar type of system.

The UEs 3112 may be any of a wide variety of communication devices, including wireless devices arranged, configured, and/or operable to communicate wirelessly with the network nodes 3110 and other communication devices. Similarly, the network nodes 3110 are arranged, capable, configured, and/or operable to communicate directly or indirectly with the UEs 3112 and/or with other network nodes or equipment in the telecommunication network 3102 to enable and/or provide network access, such as wireless network access, and/or to perform other functions, such as administration in the telecommunication network 3102.

In the depicted example, the core network 3106 connects the network nodes 3110 to one or more host computing systems, such as host 3116. These connections may be direct or indirect via one or more intermediary networks or devices. In other examples, network nodes may be directly coupled to hosts. The core network 3106 includes one more core network nodes (e.g., core network node 3108) that are structured with hardware and software components. Features of these components may be substantially similar to those described with respect to the UEs, network nodes, and/or hosts, such that the descriptions thereof are generally applicable to the corresponding components of the core network node 3108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 3116 may be under the ownership or control of a service provider other than an operator or provider of the access network 3104 and/or the telecommunication network 3102. The host 3116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 3100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 3102 is a cellular network that implements 3GPP standardized features. Accordingly, the telecommunications network 3102 may support network slicing to provide different logical networks to different devices that are connected to the telecommunication network 3102. For example, the telecommunications network 3102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 3112 are configured to transmit and/or receive information without direct human interaction. For instance, a UE may be designed to transmit information to the access network 3104 on a predetermined schedule, when triggered by an internal or external event, or in response to requests from the access network 3104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 3114 communicates with the access network 3104 to facilitate indirect communication between one or more UEs (e.g., UE 3112c and/or 3112d) and network nodes (e.g., network node 3110b). In some examples, the hub 3114 may be a controller, router, content source and analytics, or any of the other communication devices described herein regarding UEs. For example, the hub 3114 may be a broadband router enabling access to the core network 3106 for the UEs. As another example, the hub 3114 may be a controller that sends commands or instructions to one or more actuators in the UEs. Commands or instructions may be received from the UEs, network nodes 3110, or by executable code, script, process, or other instructions in the hub 3114. As another example, the hub 3114 may be a data collector that acts as temporary storage for UE data and, in some embodiments, may perform analysis or other processing of the data. As another example, the hub 3114 may be a content source. For example, for a UE that is a VR device, display, loudspeaker, or other media delivery device, the hub 3114 may retrieve VR assets, video, audio, or other media or data related to sensory information via a network node, which the hub 3114 then provides to the UE either directly, after performing local processing, and/or after adding additional local content. In still another example, the hub 3114 acts as a proxy server or orchestrator for the UEs, in particular if one or more of the UEs are low energy IoT devices.

The hub 3114 may have a constant/persistent or intermittent connection to the network node 3110b. The hub 3114 may also allow for a different communication scheme and/or schedule between the hub 3114 and UEs (e.g., UE 3112c and/or 3112d), and between the hub 3114 and the core network 3106. In other examples, the hub 3114 is connected to the core network 3106 and/or one or more UEs via a wired connection. Moreover, the hub 3114 may be configured to connect to an M2M service provider over the access network 3104 and/or to another UE over a direct connection. In some scenarios, UEs may establish a wireless connection with the network nodes 3110 while still connected via the hub 3114 via a wired or wireless connection. In some embodiments, the hub 3114 may be a dedicated hub—that is, a hub whose primary function is to route communications to/from the UEs from/to the network node 3110b. In other embodiments, the hub 3114 may be a non-dedicated hub—that is, a device which is capable of operating to route communications between the UEs and network node 3110b, but which is additionally capable of operating as a communication start and/or end point for certain data channels.

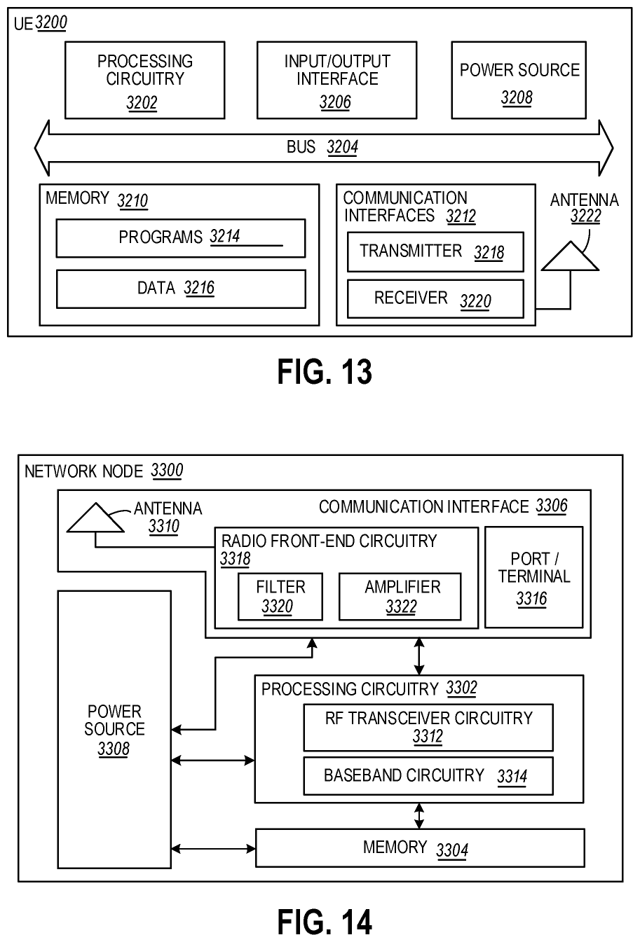

FIG. 13 shows a UE 3200 in accordance with some embodiments. The UE 3200 presents additional details of some embodiments of the UE 3112 of FIG. 12. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage/playback device, wearable terminal device, wireless endpoint, mobile station, tablet, laptop, laptop-embedded equipment (LEE), laptop-mounted equipment (LME), an Augmented Reality (AR) or Virtual Reality (VR) device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 3200 includes processing circuitry 3202 that is operatively coupled via a bus 3204 to an input/output interface 3206, a power source 3208, a memory 3210, a communication interface 3212, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 3202 is configured to process instructions and data and may be configured to implement any sequential state machine operative to execute instructions stored as machine-readable computer programs in the memory 3210. The processing circuitry 3202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 3202 may include multiple central processing units (CPUs).

In the example, the input/output interface 3206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 3200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 3208 is structured as a battery or battery pack. Other types of power sources, such as an external power source (e.g., an electricity outlet), photovoltaic device, or power cell, may be used. The power source 3208 may further include power circuitry for delivering power from the power source 3208 itself, and/or an external power source, to the various parts of the UE 3200 via input circuitry or an interface such as an electrical power cable. Delivering power may be, for example, for charging of the power source 3208. Power circuitry may perform any formatting, converting, or other modification to the power from the power source 3208 to make the power suitable for the respective components of the UE 3200 to which power is supplied.

The memory 3210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 3210 includes one or more application programs 3214, such as an operating system, web browser application, a widget, gadget engine, or other application, and corresponding data 3216. The memory 3210 may store, for use by the UE 3200, any of a variety of various operating systems or combinations of operating systems.

The memory 3210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DEVIM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 3210 may allow the UE 3200 to access instructions, application programs and the like, stored on transitory or non-transitory memory media, to off-load data, or to upload data. An article of manufacture, such as one utilizing a communication system may be tangibly embodied as or in the memory 3210, which may be or comprise a device-readable storage medium.

The processing circuitry 3202 may be configured to communicate with an access network or other network using the communication interface 3212. The communication interface 3212 may comprise one or more communication subsystems and may include or be communicatively coupled to an antenna 3222. The communication interface 3212 may include one or more transceivers used to communicate, such as by communicating with one or more remote transceivers of another device capable of wireless communication (e.g., another UE or a network node in an access network). Each transceiver may include a transmitter 3218 and/or a receiver 3220 appropriate to provide network communications (e.g., optical, electrical, frequency allocations, and so forth). Moreover, the transmitter 3218 and receiver 3220 may be coupled to one or more antennas (e.g., antenna 3222) and may share circuit components, software or firmware, or alternatively be implemented separately.

In the illustrated embodiment, communication functions of the communication interface 3212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 3212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 3200 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 3300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 14 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300. In some embodiments providing a core network node, such as core network node 108 of FIG. 14, some components, such as the radio front-end circuitry 3318 and the RF transceiver circuitry 3312 may be omitted.

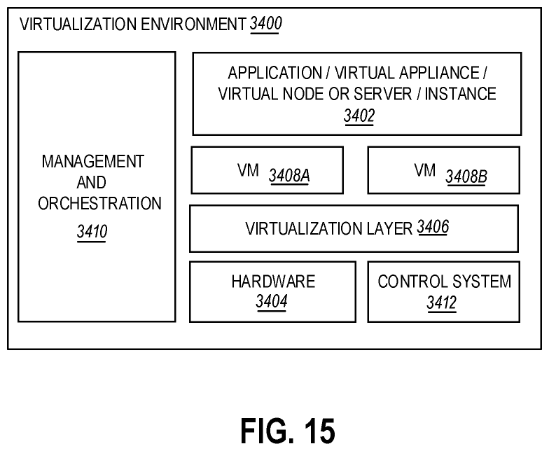

FIG. 15 is a block diagram illustrating a virtualization environment 3400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 3400 includes components defined by the O-RAN Alliance, such as an O-Cloud environment orchestrated by a Service Management and Orchestration Framework via an O-2 interface. Virtualization may facilitate distributed implementations of a network node, UE, core network node, or host.

Applications 3402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3406 (also referred to as hypervisors or virtual machine monitors (VMMs)), provide VMs 3408a and 3408b (one or more of which may be generally referred to as VMs 3408), and/or perform any of the functions, features and/or benefits described in relation with some embodiments described herein. The virtualization layer 3406 may present a virtual operating platform that appears like networking hardware to the VMs 3408.

The VMs 3408 comprise virtual processing, virtual memory, virtual networking or interface and virtual storage, and may be run by a corresponding virtualization layer 3406. Different embodiments of the instance of a virtual appliance 3402 may be implemented on one or more of VMs 3408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3408 may be a software implementation of a physical machine that runs programs as if they were executing on a physical, non-virtualized machine. Each of the VMs 3408, and that part of hardware 3404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3408 on top of the hardware 3404 and corresponds to the application 3402.

Hardware 3404 may be implemented in a standalone network node with generic or specific components. Hardware 3404 may implement some functions via virtualization. Alternatively, hardware 3404 may be part of a larger cluster of hardware (e.g. such as in a data center or CPE) where many hardware nodes work together and are managed via management and orchestration 3410, which, among others, oversees lifecycle management of applications 3402. In some embodiments, hardware 3404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3412 which may alternatively be used for communication between hardware nodes and radio units.

Although the computing devices described herein (e.g., UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE for training or evaluating a machine learning model, the method comprising:
receiving a channel measurement resource triggering signal from a network node;
performing, based at least in part on the channel measurement resource triggering signal, a first set of measurements and a second set of measurements;
generating, with the machine learning model, a plurality of predictions based on the first set of measurements; and
measuring performance of the machine learning model by performing one or more comparisons, wherein the one or more comparisons compare data from the second set of measurements and a set of predictions from the plurality of predictions.

2. The method of claim 1, wherein after performing the first and second set of measurements, the method comprises training the machine learning model with the first and second set of measurements.

3. The method of claim 1, wherein for each measurement from the first set of measurements after an initial measurement from the first set of measurements, that measurement has a corresponding separation which is a number of time slots separating that measurement from a closest preceding measurement from the first set of measurements.

4. (canceled)

5. The method of claim 3, wherein all corresponding separations for measurements from the first set of measurements after the initial measurement from the first set of measurements are specified in the channel measurement resource triggering signal.

6. (canceled)

7. The method of claim 3, wherein, for each measurement from the second set of measurements after an initial measurement from the second set of measurements:
that measurement has a corresponding separation which is a number of time slots separating that measurement from a closest preceding measurement from the second set of measurements;
that measurement has a corresponding measurement in the first set of measurements, wherein a number of measurements between that measurement and the initial measurement from the second set of measurements is equal to a number of measurements between that measurement's corresponding measurement in the first set of measurements and the initial measurement from the first of measurements; and
that measurement's corresponding separation is equal to the corresponding separation for that measurement's corresponding measurement in the first set of measurements.

8-11. (canceled)

12. The method of claim 1, wherein, for each measurement from the second set of measurements:
that measurement is of data captured during a time slot which corresponds to that measurement;
that measurement has a corresponding prediction from the set of predictions;
the one or more comparisons comprises a comparison of that measurement with its corresponding prediction from the set of predictions.

13-19. (canceled)

20. The method of claim 1, wherein the first set of measurements are measurements of non-zero power channel state information reference resources (NZP CSI-RSs) during a first NZP CSI-RS burst, and the second set of measurements are measurements of NZP CSI-RSs during a second NZP CSI-RS burst.

21. The method of claim 1, wherein:
each of prediction from the plurality of predictions comprises a predicted pre-coding matrix indicator; and
for each measurement from the second set of measurements, the one or more comparisons comprises a comparison of a pre-coding matrix indicator generated by the machine learning model from data captured in that measurement with the predicted pre-coding matrix comprised by a corresponding prediction from the set of predictions.

22-23. (canceled)

24. The method of claim 1, wherein:
the set of data collection and evaluation acts comprises training the machine learning model based on measuring the performance of the machine learning model; and
the method comprises, after training the machine learning model, using the machine learning model to generate a new prediction and use the new prediction to communicate with a network comprising the network node.

25. The method of claim 1, wherein:
the set of data collection and evaluation acts comprises monitoring the machine learning model based on measuring the performance of the machine learning model;
the method comprises:
based on monitoring the machine learning model, determining that the machine learning model should be used in communicating with a network comprising the network node; and
using the machine learning model to generate a new prediction and use the new prediction to communicate with the network comprising the network node.

26. A method performed by a network node for evaluating a machine learning model, the method comprising:
sending a channel measurement resource triggering signal to a user equipment, UE;
receiving from the UE, after sending the channel measurement resource triggering signal, a first set of measurements and a second set of measurements;
generating, with the machine learning model, a plurality of predictions based on the first set of measurements; and
measuring performance of the machine learning model by performing one or more comparisons, wherein the one or more comparisons compare data from the second set of measurements and a set of predictions from the plurality of predictions.

27. The method of claim 26, further comprising training the machine learning model with the first and second set of measurements.

28. The method of claim 26, wherein for each measurement from the first set of measurements after an initial measurement from the first set of measurements, that measurement has a corresponding separation which is a number of time slots separating that measurement from a closest preceding measurement from the first set of measurements.

29. (canceled)

30. The method of claim 28, wherein all corresponding separations for measurements from the first set of measurements after the initial measurement from the first set of measurements are specified in the channel measurement resource triggering signal.

31. (canceled)

32. The method of claim 28, wherein, for each measurement from the second set of measurements after an initial measurement from the second set of measurements:
that measurement has a corresponding separation which is a number of time slots separating that measurement from a closest preceding measurement from the second set of measurements;
that measurement has a corresponding measurement in the first set of measurements, wherein a number of measurements between that measurement and the initial measurement from the second set of measurements is equal to a number of measurements between that measurement's corresponding measurement in the first set of measurements and the initial measurement from the first of measurements; and
that measurement's corresponding separation is equal to the corresponding separation for that measurement's corresponding measurement in the first set of measurements.

33. (canceled)

34. The method of claim 32, wherein the channel measurement resource triggering signal comprises a parameter indicating a periodicity for predictions from the plurality of predictions being included in the set of predictions.

35. The method of claim 32, wherein the channel measurement resource triggering signal comprises a bitmap showing predictions from the plurality of predictions which are included in the set of predictions.

36. (canceled)

37. The method of claim 26, wherein, for each measurement from the second set of measurements:
that measurement is of data captured during a time slot which corresponds to that measurement;
that measurement has a corresponding prediction from the set of predictions;
the one or more comparisons comprises a comparison of that measurement with its corresponding prediction from the set of predictions.

38. A user equipment for evaluating a machine learning model, comprising:
processing circuitry configured to perform the steps of claim 1; and
power supply circuitry configured to supply power to the processing circuitry.

39. A network node for evaluating a machine learning model, the network node comprising:
processing circuitry configured to perform the steps of claim 26;
power supply circuitry configured to supply power to the processing circuitry.

40. (canceled)
